(19) United States
(12) Patent Application Publication
(10) Pub. No.: US 2011/0082938 A1
(43) Pub. Date: Apr. 7, 2011

(54) SYSTEMS AND METHODS FOR DYNAMICALLY UPDATING A USER INTERFACE WITHIN A VIRTUAL COMPUTING ENVIRONMENT

(76) Inventors: JOE JAUDON, Sedalia, CO (US); DAVID LOWREY, Denver, CO (US)

(21) Appl. No.: 12/575,382

(22) Filed: Oct. 7, 2009

(51) Int. Cl. G06F 3/01; G06F 15/16

(52) U.S. Cl. 709/227; 715/745

(57) ABSTRACT

The present invention provides systems and methods for dynamically manipulating and/or reconfiguring a user interface within a virtual computing environment. Specifically, various systems and methods as provided by the present invention allow for dynamic manipulation or reconfiguration of a user interface within a computing session. Depending on the embodiment, the system and method may be used for sessions provided by an application control environment or a virtual computing environment. Embodiments of the invention enable dynamic manipulation, control, and reconfiguration of the user interface within a computing environment based on user interface rules. These user interface rules may be used to implement policy and access control on users of the computing session.

### TECHNICAL FIELD

The present invention relates generally to desktop and application virtualization, and more particularly, some embodiments relate to dynamically manipulating and/or reconfiguring a user interface within a virtual computing environment.

### DESCRIPTION OF THE RELATED ART

Virtual computing is a common computing model where operating systems, desktop, and applications operate based on an abstraction of computing resources. Virtual machines, desktop virtualization and application virtualization are three common forms of virtual computing. Virtual computing machines (or simply virtual machines) are PC hardware emulated by software (commonly referred to as virtual machine software) running on a physical machine. The emulated PC hardware creates a distinct and separate “virtual machine” within the physical machine, which operates on top of and concurrently with the existing physical machine. This allows a given physical machine to host one or more virtual machines, each having its own operating system, desktop, and applications. The software running within the virtual machine is separate and distinct from the software running on the physical machine.

Desktop virtualization is another form of virtual computing which relates to remote desktop computing. In remote desktop computing, a client application or operating system feature enables an application (graphical or otherwise) or a desktop to run remotely on a remote computing machine (e.g., server). Desktop virtualization relates to remote desktop computing because desktop virtualization involves the decoupling of a user's physical machine from the software providing the desktop and related applications (e.g., server software). In one example of desktop virtualization, a desktop session operating on a remote computing device (e.g., server) or operating within a virtual machine running on a remote computing device is delivered to a client local machine (e.g., thick-client or thin-client) via a network connection. The resulting desktop (often referred to as a remote or virtual desktop) comprises a graphical user interface environment with windows, icons, menus and an input cursor (e.g. mouse pointer), all of which can be accessed by a user through the local machine as if the desktop session were operating locally.

Similarly, application virtualization is another form of virtual computing which relates to remote desktop computing where applications are allowed to function without being installed and configured directly on the terminal or computing device at the point of user access. Like virtualized desktops, virtualized applications are served up and accessed by users from the network via remote computing device (e.g., server) that hosts a platform such as Citrix®, Microsoft® Terminal Services, and VMWare®. However, unlike virtualized desktops, only the application is served to the client, and not the entire desktop.

Common examples of virtual desktop and virtual application platforms include virtual desktop infrastructures (e.g. VMWare® View, Microsoft® Hyper-V, Citrix® XenDesktop™), (stateful) thin-client services (e.g. Microsoft® Terminal Services, Citrix® XenApp®), and stateless thin-client services (e.g. Sun Microsystem's® Sun Ray™ Software).

Virtual desktop infrastructures (VDIs) are server-centric computing models where the operating system desktop (e.g. Microsoft® Windows®, GNOME, etc.) is running or hosted remotely on a full-fledge physical computer acting as a server or on a virtual machine (a software implementation of a computer whereby a self-contained operating environment within virtualized computer is provided) running on a server. Upon user login, the desktop is delivered to a client computer via a network connection such that a user is able to interact with the desktop through the client computer as if the desktop were being run/hosted locally at the client computer. Virtual desktop infrastructures are described as a “One-to-Many” design, where one specific type of VDI platform and associated virtual desktop can be served up to many types of computing devices that run a “client agent” for the VDI platform.

Thin-client services, such as Microsoft® Terminal Services and Citrix® XenApp®, are general client-server architectures where a PC, laptop, or other computer device, serving as thin-client depends primarily on a central server or host computer for the bulk of its processing activities. Generally, the thin-client computer merely displays graphics provided by the server and accepts inputs from the user. Like VDI platforms, thin-client services usually leverage client side agents to display related virtual desktops to PC's, laptops and other computing devices having the client agent. Thin-client services are also described as a “One-to-Many” design.

FIG. 1 (prior art) is a diagram illustrating a conventional “One-to-Many” system where the virtual platform, desktop, or application resides and runs on a host computer 10, such as a server, Various computing devices, such as personal digital assistants (PDAs) 12, PCs 14, laptops 16, thin-terminals 18, and smart phones 20 (e.g. iPhone®, Blackberry®), connect to the host computer 10, which delivers the virtual platform, desktop or application to the computing device over a network connection via various proprietary and non-proprietary network protocols (e.g. HTTP, UDP, ICA).

Some thin-client services are stateless such that they utilize a stateless connectivity between the thin-client and the host computer. The stateless connectivity provides the capability for portable sessions, where a user can start a session at one thin-client, and then move to another thin-client at which the original session can be resumed. In other words, the thin-client sessions are independent of the connection and can resume display of sessions that were previously disconnected. A well-known example of this architecture is the Sun Microsystems® Sun Ray™ Software, which not only provides a stateless thin-client solution but also supports delivery of different virtual platforms, desktops, and applications. Through Sun Ray™ Software, different virtual platforms, desktops and applications are virtually delivered to Sun Ray™ compatible thin-client terminals. Stateless thin-client services are described as a “Many-to-One” design, where multiple virtual platforms and associated virtual desktops (e.g. VDI, Citrix, Microsoft Terminal Services, etc.) can be served up to one specific type of compatible computing device (e.g. Sun Ray™ compatible device.) Other types of thin-client infrastructure devices can include Wyse® Thin Clients, HP® Thin Clients, etc.

FIG. 2 (prior art) is a diagram illustrating an example “Many-to-One” system where a variety of the virtual platforms 26 are running on a variety of host computers (28, 30, and 32). This variety of virtual platforms is deliverable to the thin client compatible device 22. The thin client software communicates to the virtual platforms 26 using various compatible protocols (e.g. RDP, ICA, etc). The thin client device may be controlled through a central management system, including Sun Ray™, using the Appliance Link Protocol (ALP).

Of the above-identified architectures, architectures similar in functionality to the Sun Ray™ thin-client solution allow for the benefit “smooth roaming” or “hot-desking” Citrix, Microsoft, Wyse, etc have a smooth roaming or hot-desking type of functionality to deliver the virtual desktop, application, or platform to the end user through a thin client compatible device. Smooth roaming is defined as the ability for a user to move from one terminal to another terminal and still gain access to the same session. This session may be a remote session to a remote machine or a virtual session to a virtual desktop or virtual application. Unfortunately, when smooth roaming between terminals (e.g., different computing devices), the user interface within such sessions is static and does not change in response to a change in location of access. Because different computing devices may be in different locations, the user interface may need to be reconfigured “on the fly” based on policy or access control concerns. For example, an application could be either hidden or maximized depending on the location of the user within the same logon-session.

### BRIEF SUMMARY OF EMBODIMENTS OF THE INVENTION

The present invention provides systems and methods for dynamically manipulating and/or reconfiguring a user interface within a virtual computing environment. Specifically, various systems and methods as provided by the present invention allow for dynamic manipulation or reconfiguration of a user interface within a computing session. Depending on the embodiment, the system and method may be used for sessions provided by an application control environment or a virtual computing environment. Embodiments of the invention enable dynamic manipulation, control, and reconfiguration of the user interface within a computing environment based on user interface rules. These user interface rules may be used to implement policy and access control on users of the computing session.

In one embodiment, a method for controlling a user interface in a computing environment is provided, comprising: detecting a request to establish a computing session from a terminal, wherein the computing session contains the user interface having a user interface element; determining a terminal attribute; selecting a user interface rule based on the terminal attribute, wherein the user interface rule controls, manipulates or reconfigures the user interface element based on a criterion; and applying the user interface rule to the user interface element within the computing session. In some embodiments, the user interface rule is applied only after the computing session has been established.

The user interface element within the user interface may have a user interface attribute to which the user interface rule is applied. The terminal (or thin client computing device) attribute may include terminal type (device type), terminal physical location (device physical location), terminal network location (device network location), and terminal connection type (device connection type). A terminal is a thin client computing device. The user interface attributes may include appearance, screen position, user accessibility, and behavior. The user interface rule may be selected from a datastore, such as a database.

In order to apply the user interface rule to the computing session, the method may comprise manipulating the computing session appearance and behavior in accordance with the user interface rule. In further embodiments, applying the user interface rule to the computing session comprises: intercepting a user interface action on a specific user interface element from the terminal to the server; and performing the user interface action in accordance with the user interface rule to affect control, manipulation, or reconfiguration of the specific user interface element.

Depending on the embodiment, the request to establish a computing session from a terminal may be sent from the terminal to a server providing the computing session. Additionally, the request for a computing session may comprise receiving login information from the terminal. In further embodiments, the computing session is provided by a virtual computing environment or application control environment.

In some embodiments, the criterion is based on a user interface action, a user credential, or a designation. In some such embodiments, the user interface action is creating, hiding, closing, minimizing, maximizing, normalizing, hiding, or moving a graphical window; reordering two or more graphical windows; keyboard input; creating, deleting or renaming a file; creating, deleting, renaming, or modifying a directory; changing a file attribute; changing a directory attribute; and executing, killing, or deleting a process. In other such embodiments, the designation identifies one or more specific user interface elements, one or more files, or one or more directories. In further such embodiments, the user interface criterion is based on a user credential. The user credential may include a user identity and a user group.

According to further embodiments, various operations described above are implemented such to allow computer implementation of the invention. For example, some embodiments provide for a computer program product comprising a computer useable medium having computer program code embodied therein for controlling a user interface in a computing environment in accordance with aspects of the invention as described herein.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 (prior art) is a diagram illustrating an example one-to-many system utilizing a virtual platform, desktop or application.

FIG. 2 (prior art) is a diagram illustrating an example one-to-many system utilizing the thin client device.

FIG. 3 illustrates a method for controlling a user interface in a computing environment in accordance with one embodiment of the invention.

FIG. 4 illustrates an example system and method for controlling a user interface in a computing environment in accordance with one embodiment of the invention.

FIG. 5 illustrates a computing session screen to which an embodiment of the invention could be applied.

FIG. 6 illustrates an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

The present invention is directed systems and methods for dynamically manipulating and/or reconfiguring a user interface within a virtual computing environment. Specifically, various systems and methods as provided by the present invention allow for dynamic manipulation or reconfiguration of a user interface within a computing session. Depending on the embodiment, the system and method may be used for sessions provided by an application control environment or a virtual computing environment. Embodiments of the invention enable dynamic manipulation, control, and reconfiguration of the user interface within a computing environment based on user interface rules. These user interface rules may be used to implement policy and access control on users of the computing session.

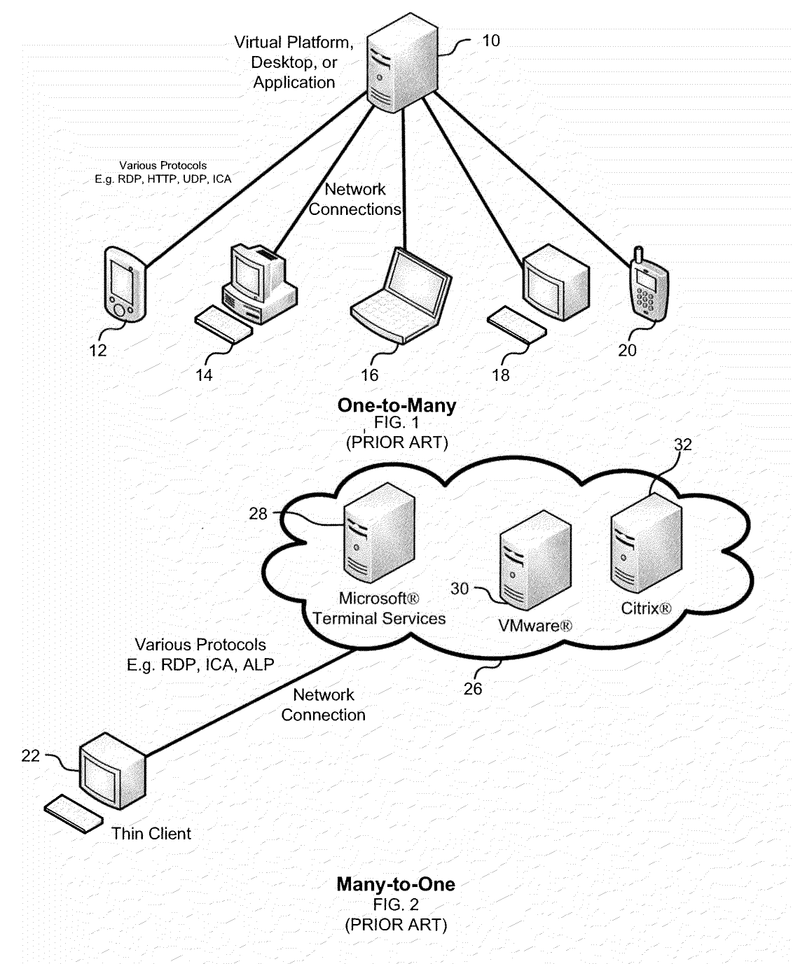

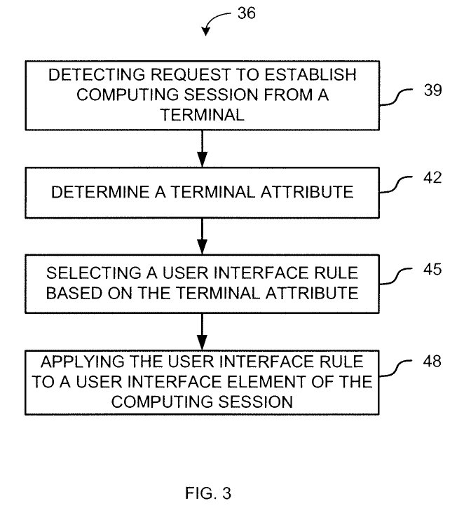

FIGS. 1 and 2 (prior art), as previously described, illustrate conventional systems in which embodiments of the present invention can be implemented. FIG. 3 illustrates an example method 36 implementing one such embodiment. Method 36 initiates upon detection 39 of a request to establish a computing session originating from a terminal. The terminal may send the request through a server operating a connection broker or connection management software, or directly to a server providing the computing session.

Next, the method 36 determines attributes of the terminal at operation 42 in order to determine what user interface rules, if any, will be applicable to the terminal sending the computing session request. As previously disclosed, user interface rules enable dynamic manipulation, control and reconfiguration of a user interface within a computing environment, such as a computing session. Attributes of the terminal include, but are in no way limited to, the connection type between the terminal and the server, the terminal type (e.g., thick-client, thin-client, laptop, PDA), the physical location of the terminal, and the network location of the terminal. For example, a specific user interface rule A may be applicable only to terminals using a wireless network connection to connect to the server, while a specific user interface rule B may be applicable only to terminals using a wired network connection. Other attributes may use a specific physical location within a building or amongst offices sites in different geographic regions. Such user interface rules could be useful, for example, when a user is moving from one terminal to the next using a roaming session.

Using the terminal attribute determined in operation 42, the method continues by selecting a user interface rule from a datastore at operation 45. The datastore from which the user interface is selected may be a SQL database or a flat file database, either of which resides at the server or at another remote computing device.

Upon selection of a use interface rule based on the terminal attribute, the method 36 commences application of the user interface rule to a user interface element of the computing session at operation 48. In some embodiments, the rule is applied by intercepting a user interface action on a specific user interface element from the terminal to the server; and performing the user interface action in accordance with the user interface rule to affect control, manipulation, or reconfiguration of the specific user interface element. For example, a user at the terminal may send a command to close a specific graphical window within the computing session, however a specific user interface rule may prohibit such an action and block the command from ever reaching the computing session provider (e.g., computing session server).

In other embodiments, the application of the user interface rule on the computing session may be facilitated by manipulating the computing session appearance and behavior in accordance with the user interface rule. For example, there could be a user interface rule for application X such that application X would be hidden at terminal A and maximized at terminal B. Such an example illustrates how a user interface rule can manipulate a computing session depending on the location from which the computing session is accessed, which can be of particular importance during a roaming session.

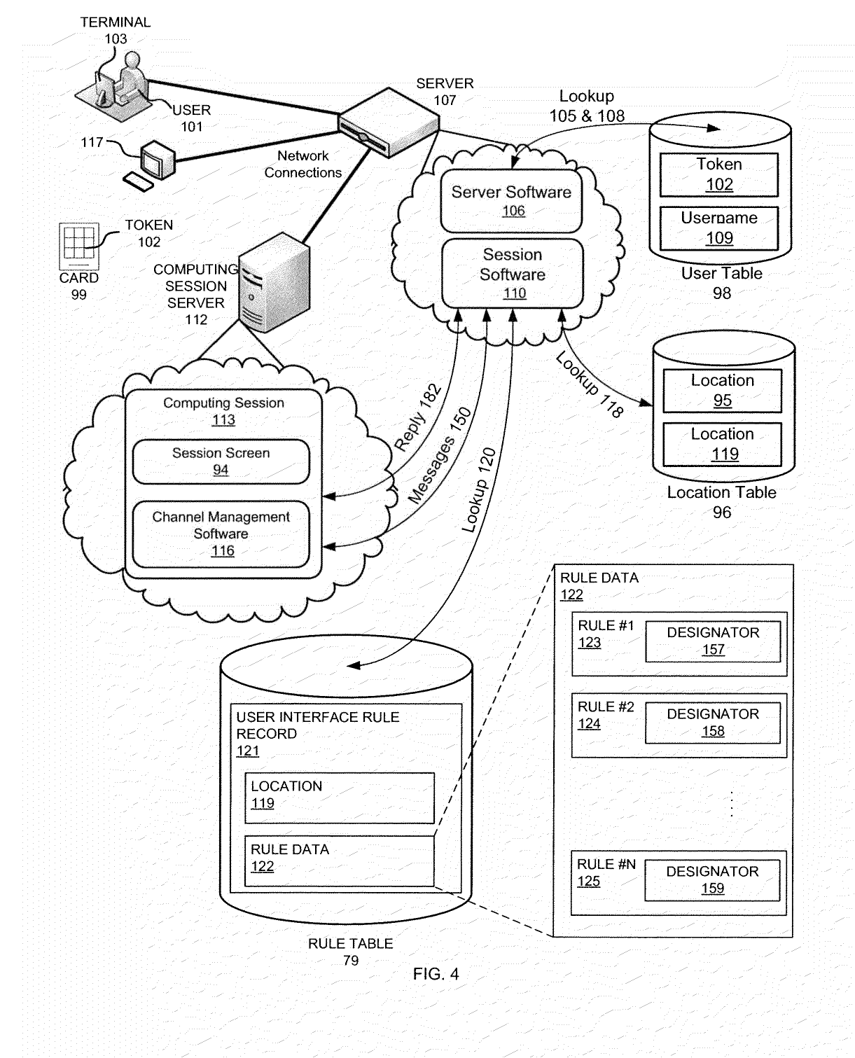

FIG. 4 illustrates an example system and method for controlling a user interface in a computing environment in accordance with one embodiment of the invention. Specifically, this example system and method illustrates how an embodiment of the current invention can be used in conjunction with session roaming capabilities. This example begins with user 101 inserting a card 99 containing a token 102 into terminal 103. A token is a user identifier. Terminal 103, in turn, sends an insert signal and the user token 102 to server software 106 hosted on server 107. Server software 106 performs a table lookup 108 on user table 98 whereby the user token 102 is uniquely associated with a username 109. Server software 106 then executes a session software 110, which initiates a channel connection with a computing session server 112, passing the earlier retrieved username 109 as a parameter. It should be noted that any of the tables described herein can be stored on one or more datastores (e.g., one or more databases).

Server 112 then creates a new computing session 113 and then binds it to username 109 if computing session 113 does not already exist. Within the computing session 113 exists a computing environment (e.g., mouse input, keyboard input and screen output) through which the user interacts with the computing session 113. By binding the computing session 113 to username 109, server 112 allows one and only one computing session 113 for username 109. Hence, if a computing session 113 already exists and is bound to username 109, no binding is required. However, if computing session 113 does not exist, server 112 creates computing session 113 and binds it to username 109.

Session software 110 then performs a table lookup 97 on location table 96, where terminal 103 is uniquely associated with a location 95. The memory variable location of session software 110 is set to this location 95 because of the table lookup 97. Computing session 113 continues by executing channel management software 116. The channel software 116 is implemented and initiated in such a manner as to facilitate bi-directional messages to and from session software 110. Through these bi-direction messages, session software 110 is able to control, manipulate, and reconfigure a user interface within computing session 113.

Assume now that user 101 moves to terminal 117 after removing card 99 containing token 102 from terminal 103. User 101 now inserts card 99 containing token 102 into terminal 117. Terminal 117 sends an insert signal and user token 102 to server software 106 hosted on server 107. Server software 106 performs a table lookup 105, which converts user token 102 into username 109. Server software 106 then connects to session software 110. Session software 110, in turn, initiates a channel connection with a computing session server 112 passing username 109 as a parameter.

Computing session server 112 connects to computing session 113 for username 109 based on the binding previously noted. Session software 110 performs table lookup 118 on location table 96, whereby terminal 117 is uniquely associated with a location 119. The memory variable location of session software 110 is compared to location 119. If location 94, which was set during user 101's previous login, is equal to location 119, processing of computing session 113 continues as normal. However, if location 94 and 119 are not equal, session software 110 performs a table lookup 120 on rule table 79 to search for any applicable user interface rule records. In this case, user interface rule record 121 is located as it is associated with location 119. User interface rule record 121 contains rule data 122 that may or may not contain one or more rules and rule designations. In this case, rule data 122 contains user interface RULE #1 through RULE #N, with each rule having a designator (e.g., 157, 158, and 159) that determines which user interface element the respective user interface rule applies to. When user interface rule 121 is retrieved for lookup 120, session software 110 sends one or more messages 150 containing rules 123-125 through the channel. Once the messages 150 arrive at channel software 116, the rules 123-125 are executed within the computing session 113. Depending upon the rule, channel software may either directly perform the task or tasks specified within the rules 123-125 or use other programs and processes to affect the same. The designators 157-159 instructs the channel software 116 to determine what user interface elements (e.g., graphical windows, buttons, icons, files, directories) the tasks within the rules 123-125 should be applied.

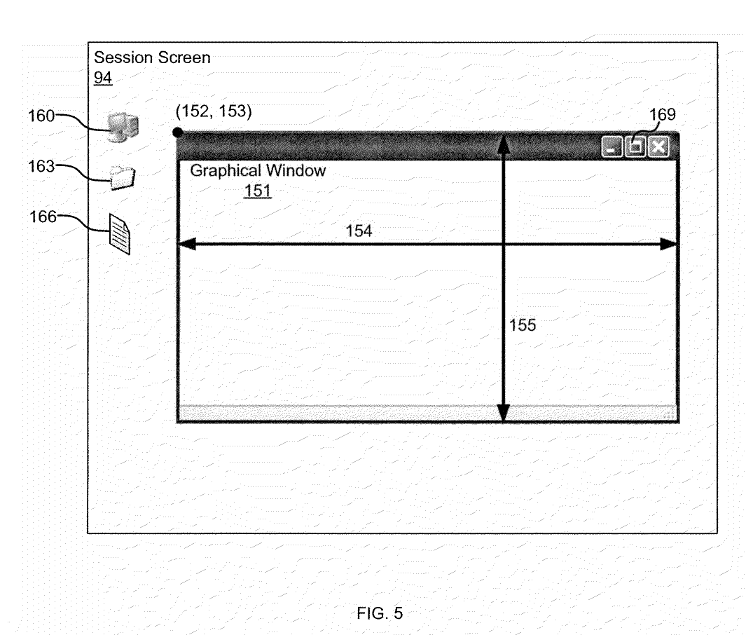

FIG. 5 illustrates a computing session screen to which an embodiment of the invention could be applied. Specifically, FIG. 5 depicts the earlier identified desktop screen 94, which is delivered to the terminals screen once a computing session is established and operating. The illustrated session screen 94 shows an icon 160, a graphical representation of a directory 163, graphical representation of a file 166, a graphical window 151, and buttons 169, all of which could be considered user interface elements under an embodiment of the invention and, as such, can be controlled, reconfigured, and manipulated by the same embodiment. Dimensions 154 and 155 represent user interface attributes of the graphical window 151 that can also be controlled, reconfigured, and manipulated in accordance with an embodiment of the invention.

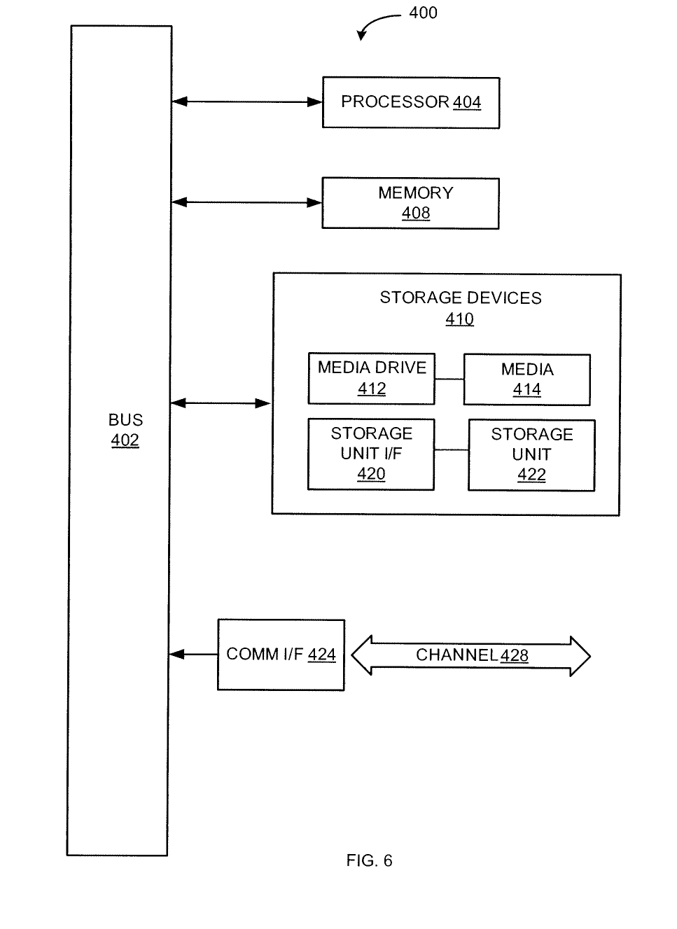

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 400. After reading this description, it will become apparent to a person skilled in the relevant art how to implement the invention using other computing modules or architectures.

Referring now to FIG. 6, computing module 400 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally.

Computing module 400 might also include one or more memory modules, simply referred to herein as main memory 408. For example, preferably random access memory (RAM) or other dynamic memory, might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a floppy disk drive, a magnetic tape drive, an optical disk drive, a CD or DVD drive (R or RW), or other removable or fixed media drive might be provided. Accordingly, storage media 414 might include, for example, a hard disk, a floppy disk, magnetic tape, cartridge, optical disk, a CD or DVD, or other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory module) and memory slot, a PCMCIA slot and card, and other fixed or removable storage units 422 and interfaces 420 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 408, storage unit 420, media 414, and signals on channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for controlling a user interface in a computing environment, comprising:
detecting a request to establish a computing session from a terminal, wherein the computing session contains the user interface having a user interface element;
determining a terminal attribute;
selecting a user interface rule based on the terminal attribute, wherein the user interface rule controls, manipulates or reconfigures the user interface element based on a criterion; and
applying the user interface rule to the user interface element within the computing session.

2. The method of claim 1, wherein applying the user interface to the computing session occurs after the computing session has been established.

3. The method of claim 1, wherein the terminal attribute includes terminal type, terminal physical location, terminal network location, and terminal connection type.

4. The method of claim 1, wherein receiving a request for a computing session further comprises receiving login information from the terminal.

5. The method of claim 1, wherein the user interface element has a user interface attribute to which the user interface rule is applied.

6. The method of claim 5, wherein the user interface attribute includes appearance, screen position, user accessibility, and behavior.

7. The method of claim 1, wherein the computing session is provided by a virtual computing environment or application control environment.

8. The method of claim 1, wherein the request is sent from the terminal to a server providing the computing session.

9. The method of claim 1, wherein the criterion is based on a user interface action, a user credential, or a designation.

10. The method of claim 9, wherein the user interface action is creating, hiding, closing, minimizing, maximizing, normalizing, hiding, or moving a graphical window; reordering two or more graphical windows; keyboard input; creating, deleting or renaming a file; creating, deleting, renaming, or modifying a directory; changing a file attribute; changing a directory attribute; and executing, killing, or deleting a process.

11. The method of claim 9, wherein the user credential includes a user identity and a user group.

12. The method of claim 9, wherein the designation identifies a specific user interface element, a file, or a directory.

13. The method of claim 1, wherein the user interface rule is selected from a datastore.

14. The method of claim 1, wherein applying the user interface rule to the computing session comprises:
intercepting a user interface action on a specific user interface element from the terminal to the server; and
performing the user interface action in accordance with the user interface rule to affect control, manipulation, or reconfiguration of the specific user interface element.

15. The method of claim 1, wherein applying the user interface rule to the computing session comprises manipulating the computing session appearance and behavior in accordance with the user interface rule.

16. A computer program product comprising a computer useable medium having computer program code embodied therein for controlling a user interface in a computing environment, comprising:
detecting a request to establish a computing session from a terminal, wherein the computing session contains the user interface having a user interface element;
determining a terminal attribute;
selecting a user interface rule based on the terminal attribute, wherein the user interface rule controls, manipulates or reconfigures the user interface element based on a criterion; and
applying the user interface rule to the user interface element within the computing session.

17. The computer program product of claim 16, wherein applying the user interface to the computing session occurs after the computing session has been established.

18. The computer program product of claim 16, wherein the terminal attribute includes terminal type, terminal physical location, terminal network location, and terminal connection type.

19. The computer program product of claim 16, wherein receiving a request for a computing session further comprises receiving login information from the terminal.

20. The computer program product of claim 16, wherein the user interface element has a user interface attribute to which the user interface rule is applied.

21. The computer program product of claim 20, wherein the user interface attribute includes appearance, screen position, user accessibility, and behavior.

22. The computer program product of claim 16, wherein the computing session is provided by a virtual computing environment or application control environment.

23. The computer program product of claim 16, wherein the request is sent from the terminal to a server providing the computing session.

24. The computer program product of claim 16, wherein the criterion is based on a user interface action, a user credential, or a designation.

25. The computer program product of claim 24, wherein the user interface action is creating, hiding, closing, minimizing, maximizing, normalizing, hiding, or moving a graphical window; reordering two or more graphical windows; keyboard input; creating, deleting or renaming a file; creating, deleting, renaming, or modifying a directory; changing a file attribute; changing a directory attribute; and executing, killing, or deleting a process.

26. The computer program product of claim 24, wherein the user credential includes a user identity and a user group.

27. The computer program product of claim 24, wherein the designation identifies a specific user interface element, a file, or a directory.

28. The computer program product of claim 16, wherein the user interface rule is selected from a datastore.

29. The computer program product of claim 16, wherein applying the user interface rule to the computing session comprises:
intercepting a user interface action on a specific user interface element from the terminal to the server; and
performing the user interface action in accordance with the user interface rule to affect control, manipulation, or reconfiguration of the specific user interface element.

30. The computer program product of claim 16, wherein applying the user interface rule to the computing session comprises manipulating the computing session appearance and behavior in accordance with the user interface rule.
